(19) United States
(12) Patent Application Publication
(10) Pub. No.: US 2005/0222744 A1
(43) Pub. Date: Oct. 6, 2005

(54) Behavior control apparatus and method for a vehicle

(76) Inventor: Kunio Sakata, Tokyo (JP)

Correspondence Address: LAW OFFICES OF;JACOBSON HOLMAN, PROFESSIONAL LIMITED LIABILITY COMPANY, 400 SEVENTH STREET, N.W., WASHINGTON, DC, 20004, US

(21) Appl. No.: 11/084,861

(22) Filed: Mar. 21, 2005

(30) Foreign Application Priority Data
Mar. 25, 2004 (JP) 2004-90288

(51) Int. Cl. G06F 19/00

(52) U.S. Cl. 701/70; 340/440

(57) ABSTRACT

A behavior control apparatus for a vehicle is disclosed which allows a driver to select permission or inhibition of control. The apparatus includes a braking control section for performing, when the vehicle behavior detected is displaced to the behavior instability side with respect to a control start reference, braking control to stabilize the vehicle behavior, and an engine output suppressing control section for performing, when the vehicle behavior detected is displaced to the behavior instability side with respect to another control start reference, control to suppress the engine output power to stabilize the vehicle behavior. If it is selected by a selection section that the engine output suppressing control should be inhibited, then the engine output suppressing control is inhibited, and further, if it is decided by a decision section that the driver has an acceleration intention, then the braking control for the stabilization of the vehicle behavior is ended.

### BACKGROUND OF THE INVENTION

1. Field of the Invention

This invention relates to a behavior control apparatus for a vehicle for suppressing an instable movement of the posture of a vehicle while securing the drivability of the vehicle.

2. Description of the Related Art

In recent years, various techniques for controlling the posture or the behavior of a vehicle upon turning so as to be stabilized have been and are being developed.

For example, a yaw moment control technique has been developed which applies braking force to a particular wheel of a vehicle upon turning to control the vehicle so as to improve the steering characteristic (steering state) of the vehicle such as understeer and oversteer to correct the posture of the vehicle in a turning direction to implement stabilized traveling of the vehicle.

In the yaw moment control, where the steering characteristic of the vehicle upon turning has a strong understeer tendency, the braking force is applied principally to a turning inner wheel or wheels to generate a yaw moment in a turning round direction on the vehicle to suppress the traveling path from swerving to the turning outer side (that is, to suppress the understeer). On the other hand, where the steering characteristic has a strong oversteer tendency, the braking force is applied principally to a turning outer wheel or wheels to generate a yaw moment in a restoration direction on the vehicle to suppress the traveling path from swerving to the turning inner side (that is, to suppress the oversteer).

As a different technique for controlling the posture of a vehicle upon turning, a roll-over suppressing control technique is available which applies braking force to a particular wheel or wheels to suppress a rolling movement (rolling state) of the vehicle. In the roll-over suppressing control, the braking force is applied to a turning outer wheel or wheels upon turning of a vehicle to slow down the vehicle to prevent an increase of a roll rate or a lateral acceleration generated on the vehicle body and suppress a movement of the vehicle toward a roll-over.

Also an engine output power suppressing control technique is available which decreases the engine output power of a vehicle to control the posture of the vehicle upon turning.

For example, Japanese Patent Laid-Open No. 2000-104582 (hereinafter referred to as Patent Document 1) discloses a configuration wherein, if it is decided that the behavior of a vehicle is in an instable state, then fuel supply to an engine is interrupted to decrease the engine output power and, after the behavior of the vehicle is placed into a stable state, the fuel supply to the engine is re-started in response to the value of the lateral acceleration (lateral G) of the vehicle. By such a configuration as just described, when the vehicle is in a state wherein the behavior thereof is instable, the engine torque is decreased to allow the wheels to grip the road surface, and then, after the behavior of the vehicle is placed into a stable state, the control for decreasing the engine torque is ended in response to the value of the lateral acceleration of the vehicle. Consequently, a stable state can be established wherein hunting of control does not occur.

On the other hand, also a technique is known wherein the braking control and the engine output power suppressing control described above are carried out in combination. For example, Japanese Patent Laid-Open No. 2000-52819 (hereinafter referred to as Patent Document 2) discloses a technique wherein, in a vehicle which includes a yaw moment control section for controlling the yaw moment and a driving force control section for adjusting at least the engine output power to control the driving force for the vehicle, excessive braking force control by the yaw moment control section is prevented. According to the technique, when a yaw moment controlling state which involves wheel spinning of driving wheels in a turning acceleration state or the like is entered while the driving force control section is controlled to an inoperative state in accordance with a demand of the driver, the driving force control section is compulsorily rendered operative by a compulsive operation section to decrease the engine output power thereby to prevent a slip of the driving wheels and prevent generation of excessive braking force by the yaw moment control section thereby to enhance the durability of the braking mechanism.

Incidentally, in the engine output power suppressing control described above, even if the driver demands the engine output power, the engine output power is suppressed regardless of the demand of the driver. Such control as described above is for allowing anybody to drive the vehicle safely and gives priority to the safety rather than the intention of the driver. However, for example, where the driver is a skilled driver, since the driver itself can stabilize the behavior of a vehicle without any problem, the driver may sometime feel such engine output power suppressing control as described above rather cumbersome because the engine output power suppressing control does not allow the driver to perform driving as intended by the driver itself.

A countermeasure against the problem just described is not disclosed in any of the documents mentioned which disclose the conventional techniques listed above. However, for the problem described above, it is a possible idea to provide a switch for allowing the driver to select a mode for permitting (carrying out of) such engine output power suppressing control and another mode for inhibiting (carrying out of) the engine output power suppressing control.

In this instance, if such a switch as just described is provided in a control configuration which performs engine output power suppressing control and braking control in combination, then even if the engine output power suppressing control is inhibited, if the braking control remains permitted to be carried out, then there is the possibility that the braking control may be performed until after the behavior of the vehicle is stabilized even if the driver has an accelerating intention. Therefore, the driver may sometimes have an unfamiliar feeling.

### SUMMARY OF THE INVENTION

It is an object of the present invention to provide a behavior control apparatus and method for a vehicle which allows a driver of the vehicle to select permission or inhibition of engine output suppressing control or braking control for stabilizing the behavior or the like of the vehicle in accordance with an intention of the driver so that the control for stabilizing the behavior or the like of the vehicle can be carried out as occasion demands.

In order to attain the object described above, according to an aspect of the present invention, there is provided a behavior control apparatus for a vehicle, comprising a braking mechanism for braking braking wheels of the vehicle, engine adjustment means for adjusting the output power of an engine of the vehicle, vehicle behavior detection means for detecting a behavior upon turning of the vehicle, braking control means for rendering, when the behavior of the vehicle detected by the vehicle behavior detection means is displaced to the behavior instability side with respect to a first control starting reference set in advance, the braking mechanism operative to perform braking control to stabilize the behavior of the vehicle, engine output suppressing control means for rendering, when the behavior of the vehicle detected by the vehicle behavior detection means is displaced to the behavior instability side with respect to a second control starting reference set in advance, the engine output adjustment means operative to perform control for suppressing the engine output power to stabilize the behavior of the vehicle, control permission/inhibition selection means for artificially selecting whether the control by the engine output suppressing control means should be permitted or inhibited, and acceleration intention decision means for deciding an acceleration intention of the driver, the control by the engine output suppressing control means being inhibited when it is selected by the control permission/inhibition selection means that the control by the engine output suppressing control means should be inhibited, the braking control for the stabilization of the behavior of the vehicle by the braking control means being ended when it is decided thereafter by the acceleration intention decision means that the driver has an acceleration intention.

In the behavior control apparatus for a vehicle, if it is selected by the control permission/inhibition selection means that the control by the engine output suppressing control means should be permitted, then when the behavior of the vehicle detected by the vehicle behavior detection means is displaced to the behavior instability side with respect to the first control starting reference set in advance, the braking control means renders the braking mechanism operative to perform the braking control to stabilize the behavior of the vehicle. Then, when the behavior of the vehicle detected by the vehicle behavior detection means is displaced to the behavior instability side with respect to the second control starting reference set in advance, the engine output suppressing control means renders the engine output adjustment means operative to perform the control for suppressing the engine output power to stabilize the behavior of the vehicle.

On the other hand, if it is selected by the control permission/inhibition selection means that the control by the engine output suppressing control means should be inhibited, then the control by the engine output suppressing control means is inhibited. In this instance, if it is decided thereafter by the acceleration intention decision means that the driver has an acceleration intention, then the braking control for the stabilization of the behavior of the vehicle by the braking control means is ended.

Consequently, when the driver demands acceleration by selective setting of the control permission/inhibition selection means, priority can be given to the acceleration rather than the behavior control of the vehicle. Thus, as occasion demands, priority can be given to any one of the vehicle behavior control for stabilizing the behavior of the vehicle and the control of the vehicle (with priority given to the drivability) which conforms to the intention of the driver, and consequently, flexible control can be anticipated.

Preferably, the behavior of the vehicle includes a behavior of the vehicle in a steering direction, and the braking control means performs, when the steering behavior of the vehicle detected by the vehicle behavior detection means is displaced to the behavior instability side with respect to the first control starting reference for the steering behavior, the braking control to stabilize the behavior of the vehicle, whereas the engine output suppressing control means performs, when the steering behavior of the vehicle detected by the vehicle behavior detection means is displaced to the behavior instability side with respect to the second control starting reference for the steering behavior, the engine output suppressing control process to stabilize the behavior of the vehicle.

With the behavior control apparatus for a vehicle, stabilization of the steering behavior of the vehicle can be anticipated. Also in this instance, any one of the stabilization control of the steering behavior of the vehicle and the control of the vehicle which conforms to the intention of the driver can be selected by the driver, and flexible control can be anticipated.

Further preferably, the braking control means ends, when the steering behavior of the vehicle detected by the vehicle behavior detection means is displaced to the behavior stability side with respect to a first control ending reference set in advance as a reference on the behavior stability side with respect to the first control starting reference for the steering behavior, the braking control for stabilizing the behavior of the vehicle, and the engine output suppressing control means ends, when the steering behavior of the vehicle detected by the vehicle behavior detection means is displaced to the behavior stability side with respect to a second control ending reference set in advance as a reference on the behavior stability side with respect to the second control starting reference for the steering behavior, the engine output suppressing control for stabilizing the behavior of the vehicle.

With the behavior control apparatus for a vehicle, unnecessary control is not continued, and the drivability of the vehicle and the behavior stabilization of the vehicle can be balanced.

Preferably, the behavior of the vehicle includes a behavior in a rolling direction of the vehicle, and the braking control means performs, when the rolling behavior of the vehicle detected by the vehicle behavior detection means is displaced to the behavior instability side with respect to the first control starting reference for the rolling behavior, the braking control to stabilize the behavior of the vehicle, whereas the engine output suppressing control means performs, when the rolling behavior of the vehicle detected by the vehicle behavior detection means is displaced to the behavior instability side with respect to the second control starting reference for the rolling behavior, the engine output suppressing control to stabilize the behavior of the vehicle.

With the behavior control apparatus for a vehicle, stabilization of the steering behavior of the vehicle can be anticipated. Also in this instance, any one of the stabilization control of the steering behavior of the vehicle and the control of the vehicle which conforms to the intention of the driver can be selected by the driver, and flexible control can be anticipated.

Further preferably, the braking control means ends, when the rolling behavior of the vehicle detected by the vehicle behavior detection means is displaced to the behavior stability side with respect to the first control ending reference set in advance as a reference on the behavior stability side with respect to the first control starting reference for the rolling behavior, the braking control for stabilizing the behavior of the vehicle, and the engine output suppressing control means ends, when the rolling behavior of the vehicle detected by the vehicle behavior detection means is displaced to the behavior stability side with respect to the second control ending reference set in advance as a reference on the behavior stability side with respect to the second control starting reference for the rolling behavior, the engine output suppressing control for stabilizing the behavior of the vehicle.

With the behavior control apparatus for a vehicle, unnecessary control is not continued, and the drivability of the vehicle and the behavior stabilization of the vehicle can be balanced.

Preferably, the behavior control apparatus for a vehicle further comprises accelerator operation amount detection means for detecting an accelerator operation amount of the vehicle, and the acceleration intention decision means decides that the driver has an acceleration intention if the accelerator operation amount detected by the accelerator operation amount detection means becomes equal to or higher than a threshold value set in advance.

Alternatively, the behavior control apparatus for a vehicle may be configured such that it further comprises accelerator operation amount increasing rate acquisition means for acquiring an increasing rate of an accelerator operation amount of the vehicle, and the acceleration intention decision means decides that the driver has an acceleration intention if the increasing rate of the accelerator operation amount acquired by the accelerator operation amount increasing rate acquisition means becomes equal to or higher than a threshold value set in advance.

With the behavior control apparatus for a vehicle, the acceleration intention of the driver can be decided precisely.

According to another aspect of the present invention, there is provided a behavior control method for a vehicle which includes a braking mechanism for braking braking wheels of the vehicle, engine adjustment means for adjusting output power of an engine of the vehicle, and vehicle behavior detection means for detecting a behavior upon turning of the vehicle, the behavior control method being for stabilizing the behavior of the vehicle by rendering, when the behavior of the vehicle detected by the vehicle behavior detection means is displaced to the behavior instability side with respect to a first control starting reference set in advance, the braking mechanism operative to perform braking control and rendering, when the behavior of the vehicle detected by the vehicle behavior detection means is displaced to the behavior instability side with respect to a second control starting reference set in advance, the engine output adjustment means operative to perform control to suppress the engine output power, the behavior control method comprising the steps of inhibiting, when the driver selects that control by engine output power suppressing control means should be inhibited through control permission/inhibition selection means for artificially selecting whether engine output power suppressing control should be permitted or inhibited, the engine output power suppressing control for stabilizing the behavior of the vehicle, and ending, when it is decided that the driver has an acceleration intention, the baking control for stabilizing the behavior of the vehicle.

Preferably, the behavior of the vehicle includes a behavior in a steering direction of the vehicle, and the behavior of the vehicle is stabilized by the braking control when the steering behavior of the vehicle detected by the vehicle behavior detection means is displaced to the behavior instability side with respect to the first control starting reference for the steering behavior, whereas the behavior of the vehicle is stabilized by the engine output power suppressing control when the steering behavior of the vehicle detected by the vehicle behavior detection means is displaced to the behavior instability side with respect to the second control starting reference for the steering behavior.

Further preferably, the braking control for stabilizing the behavior of the vehicle is ended when the steering behavior of the vehicle detected by the vehicle behavior detection means is displaced to the behavior stability side with respect to a first control ending reference set in advance as a reference on the behavior stability side with respect to the first control starting reference fir the steering behavior, and the engine output power suppressing control for stabilizing the behavior of the vehicle is ended when the steering behavior of the vehicle detected by the vehicle behavior detection means is displaced to the behavior stability side with respect to a second control ending reference set in advance as a reference on the behavior stability side with respect to the second control starting reference for the steering behavior.

Preferably, the behavior of the vehicle includes a behavior in a rolling direction of the vehicle, and the behavior of the vehicle is stabilized by the braking control when the rolling behavior of the vehicle detected by the vehicle behavior detection means is displaced to the behavior instability side with respect to the first control starting reference for the rolling behavior, whereas the behavior of the vehicle is stabilized by the engine output power suppressing control when the rolling behavior of the vehicle detected by the vehicle behavior detection means is displaced to the behavior instability side with respect to the second control starting reference for the rolling behavior.

Further preferably, the braking control for stabilizing the behavior of the vehicle is ended when the rolling behavior of the vehicle detected by the vehicle behavior detection means is displaced to the behavior stability side with respect to a first control ending reference set in advance as a reference on the behavior stability side with respect to the first control starting reference for the rolling behavior, and the engine output power suppressing control for stabilizing the behavior of the vehicle is ended when the rolling behavior of the vehicle detected by the vehicle behavior detection means is displaced to the behavior stability side with respect to a second control ending reference set in advance as a reference on the behavior stability side with respect to the second control starting reference for the rolling behavior.

Preferably, it is decided that the driver has an acceleration intention if an accelerator operation amount of the vehicle becomes higher than a threshold value set in advance.

Alternatively, it may be decided that the driver has an acceleration intention if an increasing rate of an accelerator operation amount of the vehicle becomes higher than a threshold value set in advance.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a control block diagram showing a behavior control apparatus for a vehicle according to an embodiment of the present invention;

FIG. 2 is a diagrammatic view showing a general configuration of a braking system for a vehicle which includes the behavior control apparatus for a vehicle according to the embodiment of the present invention; and

FIG. 3 is a flow chart illustrating a control end decision process by the behavior control apparatus for a vehicle according the embodiment of the present invention.

### DESCRIPTION OF THE PREFERRED EMBODIMENT

In the following, an embodiment of the present invention is described with reference to the drawings.

First, a behavior control apparatus of the present embodiment is generally configured such that control (braking control) for stabilizing the posture of a vehicle utilizing a braking system and control (engine output suppressing control) for suppressing the engine output power to stabilize the vehicle are performed. The braking control is performed principally through a braking ECU and the engine output suppressing control is performed principally by an engine ECU 7.

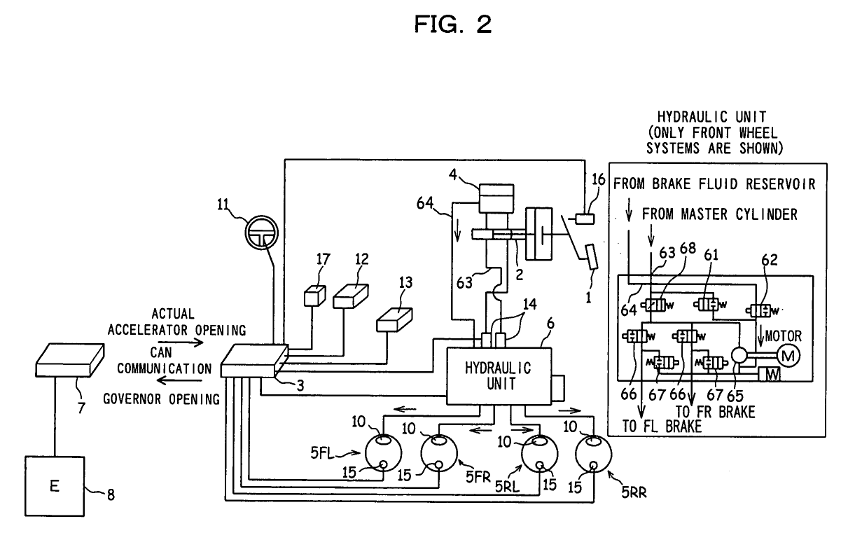

The present behavior control apparatus for a vehicle is used with such a braking system for a vehicle as shown in FIG. 2. Referring to FIG. 2, the braking system for a vehicle includes a brake pedal 1, a master cylinder 2 which operates in an interlocking relationship with an operation of the brake pedal 1, and a hydraulic unit 6 for controlling the brake fluid pressure to be supplied from the master cylinder 2 or a brake fluid reservoir 4 to wheel cylinders of wheel brakes (hereinafter referred to as brakes) 10 for braking wheels (front left and right wheels and rear left and right wheels) 5FL, 5FR, 5RL, 5RR in response to the state of the master cylinder 2 or in accordance with an instruction from a braking controller (brake ECU) 3. It is to be noted here that braking means is formed from a hydraulic pressure adjusting system including the master cylinder 2, hydraulic unit 6 and so forth and the wheel brakes 10 for the braking wheels and so forth.

Meanwhile, an engine ECU 7 is provided as engine output adjustment means for adjusting the output power of an engine 8 such that adjustment of the engine output power suitable for a state of the vehicle can be carried out through CAN communication of the engine ECU 7 with the brake ECU 3.

Braking Control

First, braking control by the present behavior control apparatus is described.

In the present embodiment, yaw moment control, roll-over suppressing control and an ASR control (spinning preventing control) are performed as the braking control.

The yaw moment control is a control process of determining a yaw moment necessary for turning round and restoration of the vehicle in response to a steering state of the vehicle and applying braking force individually to control object wheels (at least individually to the left and right wheels of the vehicle) in response to the determined yaw moment to control the movement in a yaw direction of the vehicle. The roll-over suppressing control is a controlling process of applying braking force to a turning outer wheel or wheels of the vehicle so as to prevent the roll rate and the lateral acceleration acting on the vehicle from becoming excessively high to suppress the roll-over (overturning) of the vehicle. The ASR control is a controlling process for controlling the braking force to individual driving wheels so that the driving wheels of the vehicle may not slip. The braking controls described above are performed by control sections provided independently of one another in the braking ECU 3 which serves as braking control means (braking controller).

Various signals are inputted to the brake ECU 3. In particular, a steering wheel angle signal is inputted from a steering wheel angle sensor 11 provided for the steering wheel, and a yaw rate signal of the vehicle body is inputted from a yaw rate sensor 12 provided on the vehicle body. Further, a roll rate signal (parameter value) of the vehicle body is inputted from a roll rate sensor (roll rate detection means) 13 provided on the vehicle body, and a wheel speed signal is inputted from a wheel speed sensor 15 provided for each wheel. Furthermore, a brake pedal operation signal is inputted from a brake switch 16, and a forward-backward acceleration signal and a lateral acceleration signal are inputted from a forward-backward and lateral acceleration sensor (lateral acceleration detection means) 17 provided on the vehicle body.

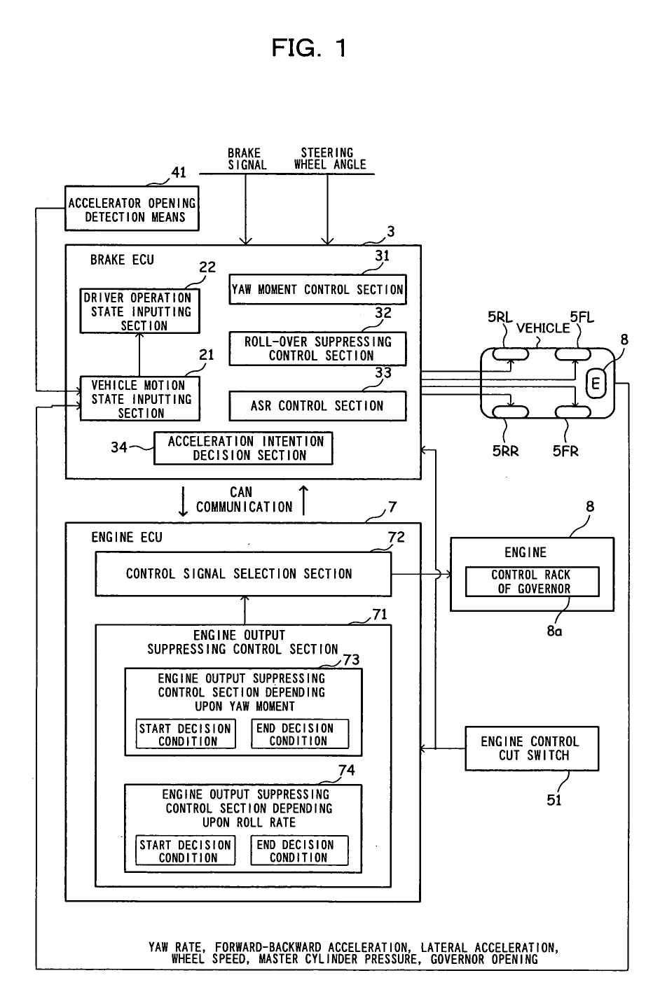

The brake ECU 3 includes such various functional elements as seen in FIG. 1. Referring to FIG. 1, the brake ECU 3 includes a vehicle motion state inputting section 21 for receiving various kinds of information relating to an operation condition (behavior) of the vehicle as inputs thereto and suitably processing the input information to calculate a theoretical motion condition of the vehicle. The brake ECU 3 further includes a driver operation state inputting section 22 for receiving various kinds of information relating to an operation state of the driver such as an accelerator operation or a brake operation as inputs thereto and suitably processing the input information. The brake ECU 3 further includes a yaw moment control section (yaw moment control means) 31 for carrying out control (yaw moment control) of the posture of the vehicle in a turning round and restoration direction. The brake ECU 3 further includes a roll-over suppressing control section (roll-over suppressing controlling means) 32 for carrying out control (roll-over suppressing control) for suppressing a roll-over (overturning) of the vehicle, and an ASR control section (spinning preventing control means) 33.

Next, the functional elements of the braking ECU 3 are described.

The vehicle motion state inputting section 21 recognizes an actual forward-backward acceleration Gₓ generated on the vehicle body from a forward-backward acceleration signal and an actual lateral acceleration G_{y} generated on the vehicle body from a lateral acceleration signal, both inputted from the forward-backward and lateral acceleration sensor 17 and recognizes a steering wheel angle θₕ from steering wheel angle information inputted from the steering wheel angle sensor 11. The vehicle motion state inputting section 21 recognizes an actual yaw rate Yᵣ generated on the vehicle body from a yaw rate signal inputted from the yaw rate sensor 12 and recognizes a roll rate Rᵣ generated on the vehicle body from a roll rate signal from the roll rate sensor 13. Then, the vehicle motion state inputting section 21 outputs the recognized information to the yaw moment control section 31, roll-over suppression control section 32 and ASR control section 33. Further, the vehicle motion state inputting section 21 here calculates a vehicle body speed V_{b}, a steering wheel angle speed ωₕ, and an actual steering angle δ. Although the vehicle body speed V_{b} is normally calculated based on wheel speed signals from the wheel speed sensors 15, if a slip occurs with a wheel, then the vehicle motion state inputting section 21 adds a time integrated value of the actual forward-backward acceleration Gₓ obtained from the forward-backward and lateral acceleration sensor 17 to the vehicle body speed based on the wheel speed signal till then to calculate the vehicle body speed (in this instance, the calculated vehicle body speed is an estimated vehicle body speed). Meanwhile, the steering wheel angle speed ωₕ and the actual rudder angle δ are calculated based on the steering wheel angle information from the steering wheel angle sensor 11. It is to be noted that, while the steering wheel angle θₕ indicates an angle of the steering wheel operated by the driver with respect to a neutral position therefor, the actual steering angle δ indicates an angle of the steering wheel with respect to the neutral position.

The driver operation state inputting section 22 decides from a brake pedal operation signal from the brake switch 16 whether or not the brake pedal 1 is operated. Further, an operation amount PR_{DR} of the brake pedal 1 by the driver is calculated based on master cylinder fluid pressure information inputted from a master cylinder fluid pressure sensor 14.

It is to be noted that the parameters calculated by the vehicle motion state inputting section 21 and the driver operation state inputting section 22 are not only used in the brake ECU 3 but also inputted to the engine ECU 7 by the CAN communication as described hereinabove.

The yaw moment control section 31 applies braking force of different levels from each other to the turning inner and outer wheels of the vehicle based on the parameters calculated by the vehicle motion state inputting section 21 and the driver operation state inputting section 22. In particular, a yaw rate (target yaw rate Yₜ) to be targeted in order for the vehicle to travel stably is calculated in accordance with the following expression 1 using a liner two-wheeled vehicle model determined as a norm:

$${Y}_{t} = LPF \cdot ( \frac{{V}_{b}}{1 + A \cdot {V}_{b}^{2}} \cdot \frac{δ}{L} ) \qquad ( 1 )$$

where V_{b} is the vehicle body speed, A is the stability factor, δ is the actual steering angle, L is the wheel base, and LPF is the filter characteristic value of a low-pass filter.

Then, a deviation (yaw rate deviation Y_{dev}) between the yaw rate Yᵣ actually generated on the vehicle and the target yaw rate Yₜ is calculated in accordance with the following expression 2:
Y_{dev}=Yₜ−Yᵣ (2)
where Y_{dev} is the yaw rate deviation, Yₜ is the target yaw rate, and Yᵣ is the actual yaw rate.

Then, a yaw moment (target yaw moment YM_{d}) necessary for turning round and restoration for stabilizing the vehicle is calculated based on the yaw rate deviation Y_{dev}. It is to be noted that it is decided based on the positive or negative sign of the target yaw moment YM_{d} value whether the steering characteristic of the vehicle is in an oversteer tendency or in an understeer tendency. In particular, it is decided that, where the target yaw moment YM_{d} value is positive, the steering characteristic of the vehicle is in an understeer tendency, but where the target yaw moment YM_{d} value is negative, it is decided that the steering characteristic of the vehicle is in an oversteer tendency.

In particular, in the present embodiment, the yaw moment control section 31 functions as steering characteristic detection means for detecting a steering state of the vehicle, that is, a yaw rate deviation.

Further, the yaw moment control section 31 includes a start decision section and an end decision section of the yaw moment braking control for controlling the magnitude of the yaw moment to be generated on the vehicle body. The starting decision section decides whether or not the yaw moment braking control should be started, and the ending decision section decide whether or not the yaw moment braking control should be ended. Such decisions are made depending upon whether or not a predetermined start condition and a predetermined end condition are satisfied, respectively. If the predetermined start condition is satisfied, then the yaw moment braking control is carried out, and if the predetermined end condition is satisfied, then the yaw moment braking control is ended.

The start condition (first control starting reference) of the yaw moment braking control is that all of a condition (1) that the vehicle body speed V_{b} is equal to or higher than a reference value (low speed value set in advance) V₁, and (2) that, when the vehicles is in an oversteer sate, the yaw rate deviation Y_{dev} is lower than a value (negative value) calculated by multiplying a reference value (reference yaw rate as a threshold value set in advance) Yₒₛₜ by a correction gain K, or, when the vehicle is in an understeer state, the yaw rate deviation Y_{dev} is higher than a value calculated by multiplying a reference value (reference yaw rate as a threshold value set in advance) Yᵤₛₜ by the correction gain K are satisfied. If all of the conditions are satisfied, then the yaw moment braking control is started.

It is to be noted that, in the present embodiment, absolute values of the reference value Yₒₛₜ and reference value Yᵤₛₜ are set equal to each other. In particular, the yaw rate deviation Y_{dev} is detected as a positive value where the state of the steering characteristic of the vehicle is an understeer state, but the yaw rate deviation Y_{dev} is detected as a negative value where the state of the steering characteristic of the vehicle is an oversteer state. Therefore, in any case, when the magnitude of the yaw rate deviation Y_{dev} becomes higher than the reference value, the yaw moment braking control can be started.

On the other hand, the end condition (first control ending reference) of the yaw moment braking control is that any one of a condition (1) that the vehicle body speed V_{b} is lower than a reference value (low-speed value set in advance) V₂ (where, V₂<V₁) and another condition (2) that the yaw rate deviation Y_{dev} continues to be lower than a reference value Yₑₕₘ for predetermined time Tₑₕₘ or more is satisfied. If any one of the conditions is satisfied, then the yaw moment braking control is ended.

The roll over suppression control section 32 applies the braking force to a turning outer wheel or wheels of the vehicle based on the parameters calculated by the vehicle motion state inputting section 21 and the driver operation state inputting section 22. In particular, if a predetermined stat condition based on the value of the roll rate Rᵣ is satisfied, then control of applying the braking force corresponding to the magnitude of the roll rate Rᵣ to the turning outer wheel or wheels is performed. Further, if a predetermined end condition is satisfied, then the control is ended. Further, the braking force corresponding to the magnitude of the roll rate Rᵣ in the controlling process is arithmetically operated in the roll over suppression control section 32.

It is to be noted that the start condition (first control starting reference) of the roll rate control in the present embodiment is that all of a condition (1) that the vehicle body speed V_{b} is equal to or higher than the reference value (low speed value set in advance) V₁, another condition (2) that the magnitude of the lateral acceleration G_{y} is equal to or greater than a reference value (value set in advance) G_{ys1}, and a further condition (3) that the magnitude of the roll rate Rᵣ is equal to or greater than a reference value (first control start threshold value set in advance) Rᵣₛ are satisfied. If all of the conditions are satisfied, then the roll rate controlling process is started. The start condition described above includes a turning start condition of the vehicle, and when all of the conditions described above are satisfied, naturally the vehicle is in a turning state. Further, in the present embodiment, the reference value G_{ys1} for the lateral acceleration G_{y} decided in the start condition (2) is set to a very low value. In particular, the lateral acceleration G_{y} here is included not as a parameter for deciding the roll state of the vehicle but as a parameter for deciding turning a start of turning of the vehicle in the start condition. Accordingly, the conditions of the start condition for the roll rate control are substantially based on the value of the roll rate Rᵣ.

Meanwhile, the end condition (first control ending reference) of the roll rate control is that any one of a condition (1) that the vehicle body speed V_{b} is lower than the reference value (low-speed value set in advance) V₂ (where V₂<V₁), another condition (2) that the turning direction is changed over, and a further condition (3) that the magnitude of the roll rate Rᵣ is lower than a reference value (control end threshold value set in advance) R_{rE} (where R_{rE}<Rᵣₛ) is satisfied. If any one of the conditions is satisfied, then the roll rate control is ended. It is to be noted that the changeover of the turning direction is decided when the sign of the yaw rate Yr is reversed.

The ASR control section 33 controls the braking force to the driving wheels so as to prevent a slip of the driving wheels of the vehicle based on the parameters calculated by the vehicle motion state inputting section 21 and the driver operation state inputting section 22. In particular, the ASR control section 33 supervises a slip of each driving wheel from the wheel speed signal from the wheel speed sensor 15, the vehicle body speed V_{b} calculated by the vehicle motion state inputting section 21 or the like, and performs the braking control when a slip appears. Further, if both of the left and right wheels slip, then the ASR control section 33 decides that the wheels rotate but idly, and performs control (ASR engine output suppressing control) for reducing the engine output power together with the braking control described hereinabove. Consequently, starting force on a low μ road such as a snowy road is secured and the stability upon acceleration is enhanced.

The ASR engine output suppressing control signal is inputted to a control signal selection section 72 of the engine ECU 7 hereinafter described. In other words, after a start decision or an end decision is performed by the ASR control section 33, such a start or an end of the control described above is executed by the control signal selection section 72 of the engine ECU 7.

It is to be noted that, although the brake ECU 3 includes, as additional control sections, an automatic slowdown control section (not shown) for arithmetically operating the turning radius upon turning of the vehicle and the coefficient of friction of the traveling road surface to automatically slow down the speed of the vehicle and several other control sections, description of the additional control sections is omitted herein.

Engine Output Suppressing Control

Now, the engine output suppressing control of the present behavior control apparatus is described.

In the present embodiment, the engine output suppressing control is carried out using two control modes of engine output suppressing control which depends upon the yaw rate (steering-corresponding engine output suppressing control) and engine output suppressing control which depends upon the roll rate (rolling-corresponding engine output suppressing control). In the steering-corresponding engine output suppressing control and the rolling-corresponding engine output suppressing control, a control rack (engine output adjustment means) 8a of a governor of the engine 8, which here is a diesel engine, is operated to restrict the output power of the engine (in the present embodiment, to reduce the fuel injection amount) to lower the vehicle speed so that the vehicle can be stabilized in regard to the steering state or the rolling state.

It is to be noted that the engine 8 may be any prime mover only if it can generate driving force for the vehicle and includes not only engines such as gasoline engines but also driving motors for electric automobiles and so forth. Accordingly, if a gasoline engine is used, then the output power of the engine can be restricted by reducing the intake air amount and the fuel injection amount, and if a driving motor is used, then the output power of the engine (motor) can be restricted by reduction of the current supply to the motor and so forth.

The engine output suppressing control which depends upon the yaw moment is engine output suppressing control of grasping the vehicle behavior in the form of the steering state (steering characteristic or yaw moment) of the vehicle and stabilizing the steering state. Here, the steering state of the vehicle signifies a mode of the posture of the vehicle regarding the yaw direction such as, for example, understeer or oversteer upon turning of the vehicle. The yaw rate deviation Y_{dev} is used as a parameter which indicates the steering state.

Meanwhile, the engine output suppressing control which depends upon the roll rate is engine output suppressing control of grasping the vehicle behavior in the form of the rolling state (roll rate) of the vehicle and stabilizing the rolling state. Here, the rolling state signifies a state of the posture of the vehicle regarding the rolling direction as decided from, for example, the lateral acceleration or the roll rate. The roll rate Rᵣ is used as a parameter which indicates the rolling state. The engine ECU 7 includes decision sections corresponding to the two control modes.

It is to be noted that the parameters regarding the start and the end of the engine control described in detail below are inputted by CAN communication from the brake ECU 3 as occasion demands. For example, the yaw rate deviation Y_{dev} is inputted from the yaw moment control section 31, and the roll rate Rᵣ is inputted from the vehicle motion state inputting section 21.

The engine ECU 7 includes an engine output suppressing control section (engine output suppressing control means) 71 and a control signal selection section 72. The engine output suppressing control section 71 includes an engine output suppressing control section 73 for stabilizing the behavior of the vehicle regarding the yaw moment of the vehicle (that is, the behavior of the vehicle in the steering direction) and another engine output suppressing control section 74 for stabilizing the behavior of the vehicle regarding the roll rate of the vehicle (that is, the behavior of the vehicle in the rolling direction). Each of the control sections 73 and 74 decides whether or not the engine output suppressing control thereof should be started or ended and carries out the control based on the decision. Naturally, the engine output suppressing control section 73 which depends upon the yaw moment decides a start or an end of the control based on the yaw moment of the vehicle, and the engine output suppressing control section 74 which depends upon the roll rate decides a start or an end of the control based on the roll rate of the vehicle.

The start condition (second control start reference) of the engine output suppressing control by the engine output suppressing control section 73 which depends upon the yaw moment is that all of a condition (1) that the vehicle body speed V_{b} is equal to or higher than a reference value (low speed value set in advance) V₁, and another condition (2) that, when the steering state is oversteer, the yaw rate deviation Y_{dev} is lower than a value (negative value) obtained by multiplying a second reference value (reference yaw rate as a threshold value set in advance) Yₒₛₜₑ by a correction gain K, or, when the steering state is understeer, the yaw rate deviation Y_{dev} is higher than a value obtained by multiplying a second reference value Yᵤₛₜₑ (reference yaw rate as a threshold value set in advance) by the correction gain K, are satisfied. If all of the conditions are satisfied, then the result of the decision is inputted to the control signal selection section 72, and the engine output suppressing control which depends upon the yaw moment is started.

The second reference values Yₒₛₜₑ and Yᵤₛₜₑ used in the engine output suppressing control are set as values having magnitudes greater than those of the reference values Yₒₛₜ and Yᵤₛₜ used in the yaw moment control, respectively, that is, as values corresponding to more instable states of the steering characteristic of the vehicle. Consequently, the engine output suppressing control which depends upon the yaw moment is not started unless the steering characteristic of the vehicle is in a more instable state than that by the yaw moment control described hereinabove.

This arises from the following reason. In particular, when the disorder of the behavior of the vehicle is small, the driver can perform an accelerator operation, and if the output power of the engine is restricted by the present engine output suppressing control, then sometimes it rather deteriorates the operability. However, when the disorder of the behavior of the vehicle is great, it is desirable not only to rely upon the operation of the driver but also to restrict the output power of the engine through the present engine output suppressing control to achieve enhancement of the stability of the vehicle. Accordingly, the reference value for the start condition of the present engine output suppressing control is set higher than the reference value for the yaw moment control (that is, the decision condition is set severer) so that the present engine output suppressing control is carried out when the disorder of the behavior of the vehicle is comparatively great.

It is to be noted that, while, in the present embodiment, the second reference value Yₒₛₜₑ for the oversteer state and the second reference value Yᵤₛₜₑ for the understeer state are set to an equal value, they may otherwise be set to different values, for example, depending upon the steering characteristic.

Meanwhile, the end condition (second control end reference) for the engine output suppressing control of the engine output suppressing control section 73 which depends upon the yaw moment is that any one of a condition (1) that the vehicle body speed V_{b} is lower than a reference value (low speed value set in advance) V₂ (where V₂<V₁) and another condition (2) that the yaw rate deviation Y_{dev} continues to be lower than a reference value Yₑₕₘ for predetermined period Tₑₕₘ or more is satisfied. If any one of the conditions is satisfied, then the result of the decision is inputted to the control signal selection section 72, and the engine output suppressing control which depends upon the yaw moment is ended. Thus, the end condition of the engine output suppressing control which depends upon the yaw moment is the same as the end condition of the yaw moment control described hereinabove, and if the end condition is satisfied, then it is determined that the steering characteristic of the vehicle has been placed into a stable state and the both controls are ended. In other words, before the state of the steering characteristic of the vehicle satisfies the end condition described above, both of the yaw moment control and the engine output suppressing control which depends upon the yaw moment are carried out to secure the stability of the vehicle.

As described above, in the present embodiment, the engine output suppressing control which depends upon the yaw moment relies upon the yaw moment control, and when the engine output suppressing control which depends upon the yaw moment is carried out, also the yaw moment control is carried out.

On the other hand, the start condition (second control start reference) of the engine output suppressing control by the engine output suppressing control section 74 which depends upon the roll rate is that all of a condition that (1) the vehicle body speed V_{b} is equal to or higher than the reference value (low speed value set in advance) V₁, another condition (2) that the lateral acceleration G_{y} is equal to or higher than a reference value G_{ys1} (value set in advance) and a further condition (3) that the magnitude of the roll rate Rᵣ is equal to or greater than a reference value (control start threshold value set in advance) Rᵣₛ are satisfied. If all of the conditions are satisfied, then the result of the decision is inputted to the control signal selection section 72, and the engine output suppressing control which depends upon the roll rate is started.

The end condition (second control end reference) of the engine output suppressing control by the engine output suppressing control section 74 which depends upon the yaw moment is that any one of a condition that (1) the vehicle body speed V_{b} is lower than the reference value (low speed value set in advance) V₂ (where V₂<V₁), another condition (2) that the turning direction is changed over, and a further condition (3) that the magnitude of the roll rate Rᵣ is lower than a reference value (control threshold value set in advance) R_{rE} (where R_{rE}<Rᵣₛ) is satisfied. If any one of the conditions is satisfied, then the result of the decision is inputted to the control signal selection section 72, and the engine output suppressing control which depends upon the roll rate is ended.

The start condition and the end condition are the same as the start condition and the end condition of the roll-over suppressing control by the roll-over suppressing control section 32, respectively. In other words, if the start condition of the roll-over suppressing control is satisfied in the roll-over suppressing control section 32, then also the start condition of the engine output suppressing control which depends upon the yaw moment is satisfied in the engine output suppressing control section 74, and when the end condition of the roll-over suppressing control is satisfied, also the end condition of the engine output suppressing control is satisfied. Accordingly, in the present embodiment, the engine output suppressing control which depends upon the roll rate relies upon the roll-over suppressing control, and the roll-over suppressing control and the engine output suppressing control which depends upon the roll rate are executed simultaneously.

This is because, since, in the roll-over suppressing control, different from the yaw moment control, it is effective to slow down the vehicle promptly in order to secure the stability, it is intended to make the reference values of the start condition of the present engine output suppressing control equal to the reference values used in the roll-over suppressing control so that the controls may be carried out simultaneously.

The start and end decisions of the control by the engine output suppressing control section 73 which depends upon the yaw moment and the control by the engine output suppressing control section 74 which depends upon the roll rate are inputted to the control signal selection section 72 to perform actual control.

The control signal selection section 72 can reduce the engine output power with a control amount based on the magnitude of the yaw moment when the start condition of the engine output suppressing control which depends upon the yaw moment is satisfied. Similarly, when the start condition of the engine output suppressing control which depends upon the roll rate is satisfied, the control signal selection section 72 can reduce the engine output power with a control amount based on the magnitude of the roll rate.

It is to be noted that, in the present embodiment, in all of the engine output suppressing controls described above, the opening of the governor (not shown) is restricted with a fixed gradient set in advance to reduce the injection amount of fuel to be supplied to the engine to reduce the engine output power. Further, when the end conditions of both of the engine output suppressing controls are satisfied, then the opening of the governor is opened with a fixed gradient set in advance to restore the engine output power (for example, the original engine output power which is based on the operation of the accelerator by the driver is restored).

Further, if the control start condition is satisfied in both of the engine output suppressing control which depends upon the yaw moment and the engine output suppressing control which depends upon the roll rate, then the control signal selection section 72 gives priority to that control which has been started earlier in time to perform the control.

In particular, for example, if the start condition of the engine output suppressing control which depends upon the yaw moment is satisfied first and then the start condition of the engine output suppressing control which depends upon the roll rate is satisfied and hence the start conditions of both control are satisfied, then the control signal selection section 72 gives priority only to the engine output suppressing control which depends upon the yaw moment and has been started earlier in time and executes this control. Accordingly, the control amount of the engine output suppressing control which depends upon the yaw moment and the control amount of the engine output suppressing control which depends upon the roll rate are not added thereby to prevent the engine output power from being suppressed excessively.

Thereafter, if the end condition of the engine output suppressing control which depends upon the yaw moment is satisfied while the end condition of the engine output suppressing control which depends upon the roll rate is not satisfied as yet, then the engine output suppressing control which depends upon the roll rate is carried out.

Further, the control signal selection section 72 preferentially carries out the engine output suppressing control which depends upon the roll rate and the engine output suppressing control which depends upon the yaw moment rather than the ASR control. In particular, while any of the engine output suppressing control which depends upon the roll rate and the engine output suppressing control which depends upon the yaw moment is being carried out, the ASR control is not carried out.

Incidentally, the present apparatus includes a selection switch (engine control cut switch) 51 serving as control permission/inhibition selection means for selecting a mode (engine output suppressing control permission mode) in which carrying out of the engine output suppressing control is permitted and another mode (engine output suppressing control inhibition mode) in which carrying out of the engine output suppressing control is inhibited.

If the engine output suppressing control permission mode is set by the engine control cut switch 51, then the engine output suppressing control section 71 (73, 74) carries out the engine output suppressing controls described hereinabove while the control conditions described hereinabove remain satisfied (within a period before the control end condition is satisfied after the control start condition is established) . However, if the engine output suppressing control inhibition mode is set by the engine control cut switch 51, then the engine output suppressing control described above is not carried out irrespective of whether or not the control conditions described hereinabove are satisfied.

The brake ECU 3 further includes a function (acceleration intention decision section) 34 of deciding the acceleration intension of the driver and decides the acceleration intention of the driver based on detection information of an accelerator opening sensor (accelerator opening detection means) 41 inputted to the vehicle motion state inputting section 21. More particularly, the acceleration intention decision section 34 decides that the driver has an acceleration intention when the accelerator opening (accelerator operation amount) detected by the accelerator opening sensor 41 is equal to or higher than a threshold value set in advance.

It is to be noted that the acceleration intention decision section 34 may be configured otherwise such that it includes, for example, a function (accelerator operation amount increasing rate acquisition section) of acquiring the accelerator opening rate (increasing rate of the accelerator operation amount) by time differentiating the accelerator opening detected by the accelerator opening sensor 41 or by a like means such that, if the accelerator opening rate (increasing rate of the accelerator operation amount) acquired by the accelerator operation amount increasing rate acquisition section is equal to or higher than a threshold value set in advance, then it is decided that the driver has an acceleration intention.

Also it is possible to configure the acceleration intention decision section 34 otherwise such that, when one of a condition that the accelerator opening is equal to or higher than a threshold value set in advance and another condition that the accelerator opening rate is equal to or higher than a threshold value set in advance is satisfied, it is decided that the driver has an acceleration intention or such that, when both of a condition that the accelerator opening is equal to or higher than a threshold value set in advance and another condition that the accelerator opening rate is equal to or higher than a threshold value set in advance are satisfied, it is decided that the driver has an acceleration intention.

Then, where the engine output suppressing control inhibition mode is set by the engine control cut switch 51, if braking control (the yaw moment control by the yaw moment control section 31 or the roll-over suppressing control by the roll-over suppressing control section 32) is being carried out, then the brake ECU 3 ends the braking control at a point of time when it is decided by the acceleration intention decision section 34 that the driver has an acceleration intention.

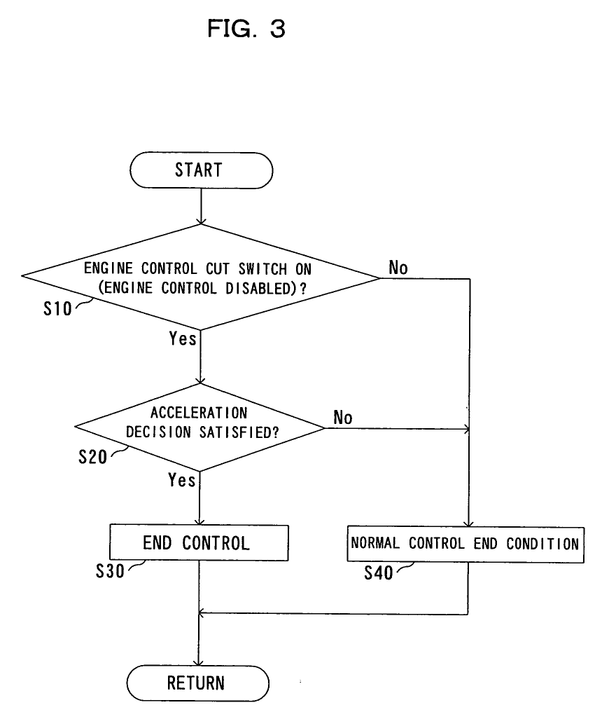

The behavior control apparatus for a vehicle according to the embodiment of the present invention is configured in such a manner as described above and, while the engine control cut switch 51 is set to an on state (engine output suppressing control inhibition mode), the engine output suppressing control is inhibited, but the braking control is started if the end condition is satisfied. Accordingly, where attention is paid to an end of the braking control, if it is decided by the decision of whether or not the engine control cut switch 51 is on (step S10 of FIG. 3) that the engine control cut switch 51 is on, then it is decided during the braking control whether or not the driver has an acceleration intension (step S20). If it is decided that the driver has a a cceleration intention, then the braking control is ended at the point of time (step S30). However, if it is decided at step S20 that the driver does not have an acceleration intention, then the normal control end condition is satisfied, and consequently, the braking control is ended (step S40).

On the other hand, if the engine control cut switch 51 is set to an off state at step S10, then the engine output suppressing control and the braking control are carried out based on the normal control start and end conditions, and even where attention is paid to an end of the braking control, the braking control is ended because of satisfaction of the normal control end condition (step S40).

In this manner, where the engine control cut switch 51 is set to an on state, the engine output suppressing control is inhibited naturally. Further, at this time, whether or not the driver has an acceleration intention is decided in predetermined cycles based on the accelerator opening, accelerator opening rate and so forth by the acceleration intention decision section 34, and if it is decided that the driver has an acceleration intention, then the braking control is ended.

Accordingly, if the driver attaches importance to the operability (drivability) of the vehicle rather than the behavior control of the vehicle and sets the engine control cut switch 51 to an on state, then the braking control is carried out in a normal manner until after the driver indicates an acceleration intention, but when the driver indicates an acceleration intention, the braking control which has been carried out till then is ended at the point of time. Therefore, the behavior control of the vehicle can be carried out within a range within which it does not disturb an acceleration intention of the driver, and while the drivability is secured, the behavior stability of the vehicle can be enhanced.

Further, since the acceleration intention decision section 34 decides it based on the accelerator opening, accelerator opening rate and so forth whether or not the driver has an acceleration intension, the acceleration intention of the driver can be decided readily and precisely.

While a preferred embodiment of the present invention has been described above, the present invention is not limited to the embodiments, but can be carried out in various modified forms without departing from the spirit and scope of the present invention.

For example, while, in the embodiment described above, both of the braking control and the engine output suppressing control are used in steering control (yaw moment control) for stabilizing the behavior of the vehicle in the steering direction and in rolling control (rolling suppressing control) for stabilizing the behavior of the vehicle in the rolling direction, one or both of the braking control and the engine output suppressing control may be used in only one of the yaw moment control and the rolling suppressing control.

In this instance, those of the components of the apparatus other than those which relate to one of the yaw moment control and the rolling suppressing control can naturally be omitted.

Further, while, in the embodiment described above, in order to control the suppression amount of the engine output power in the engine output suppressing control, the opening of the governor (not shown) is restricted with a fixed gradient set in advance to decrease the injection amount of fuel to be supplied to the engine to decrease the engine output power, the control amount may otherwise be varied in response to the magnitude of the yaw moment or the roll rate or otherwise in response to the steering characteristic or an operation state of the vehicle. Naturally, the suppression amount of the engine output power may be set to different values in the engine output suppressing control which depends upon the yaw moment and the engine output suppressing control which depends upon the roll rate.

1. A behavior control apparatus for a vehicle, comprising:
a braking mechanism for braking braking wheels of said vehicle;
engine adjustment means for adjusting the output power of an engine of said vehicle;
vehicle behavior detection means for detecting a behavior upon turning of said vehicle;
braking control means for rendering, when the behavior of said vehicle detected by said vehicle behavior detection means is displaced to the behavior instability side with respect to a first control starting reference set in advance, said braking mechanism operative to perform braking control to stabilize the behavior of said vehicle;
engine output suppressing control means for rendering, when the behavior of said vehicle detected by said vehicle behavior detection means is displaced to the behavior instability side with respect to a second control starting reference set in advance, said engine output adjustment means operative to perform control for suppressing the engine output power to stabilize the behavior of said vehicle;
control permission/inhibition selection means for artificially selecting whether the control by said engine output suppressing control means should be permitted or inhibited; and
acceleration intention decision means for deciding an acceleration intention of the driver;
the control by said engine output suppressing control means being inhibited when it is selected by said control permission/inhibition selection means that the control by said engine output suppressing control means should be inhibited, the braking control for the stabilization of the behavior of said vehicle by said braking control means being ended when it is decided thereafter by said acceleration intention decision means that the driver has an acceleration intention.

2. The behavior control apparatus for a vehicle as claimed in claim 1, wherein the behavior of said vehicle includes a behavior of said vehicle in a steering direction, and said braking control means performs, when the steering behavior of said vehicle detected by said vehicle behavior detection means is displaced to the behavior instability side with respect to the first control starting reference for the steering behavior, the braking control to stabilize the behavior of said vehicle, whereas said engine output suppressing control means performs, when the steering behavior of said vehicle detected by said vehicle behavior detection means is displaced to the behavior instability side with respect to the second control starting reference for the steering behavior, the engine output suppressing control process to stabilize the behavior of said vehicle.

3. The behavior control apparatus for a vehicle as claimed in claim 2, wherein said braking control means ends, when the steering behavior of said vehicle detected by said vehicle behavior detection means is displaced to the behavior stability side with respect to a first control ending reference set in advance as a reference on the behavior stability side with respect to the first control starting reference for the steering behavior, the braking control for stabilizing the behavior of said vehicle, and said engine output suppressing control means ends, when the steering behavior of said vehicle detected by said vehicle behavior detection means is displaced to the behavior stability side with respect to a second control ending reference set in advance as a reference on the behavior stability side with respect to the second control starting reference for the steering behavior, the engine output suppressing control for stabilizing the behavior of said vehicle.

4. The behavior control apparatus for a vehicle as claimed in claim 1, wherein the behavior of said vehicle includes a behavior in a rolling direction of said vehicle, and said braking control means performs, when the rolling behavior of said vehicle detected by said vehicle behavior detection means is displaced to the behavior instability side with respect to the first control starting reference for the rolling behavior, the braking control to stabilize the behavior of said vehicle, whereas said engine output suppressing control means performs, when the rolling behavior of said vehicle detected by said vehicle behavior detection means is displaced to the behavior instability side with respect to the second control starting reference for the rolling behavior, the engine output suppressing control to stabilize the behavior of said vehicle.

5. The behavior control apparatus for a vehicle as claimed in claim 3, wherein the behavior of said vehicle includes a behavior in a rolling direction of said vehicle, and said braking control means performs, when the rolling behavior of said vehicle detected by said vehicle behavior detection means is displaced to the behavior instability side with respect to the first control starting reference for the rolling behavior, the braking control to stabilize the behavior of said vehicle, whereas said engine output suppressing control means performs, when the rolling behavior of said vehicle detected by said vehicle behavior detection means is displaced to the behavior instability side with respect to the second control starting reference for the rolling behavior, the engine output suppressing control to stabilize the behavior of said vehicle.

6. The behavior control apparatus for a vehicle as claimed in claim 5, wherein said braking control means ends, when the rolling behavior of said vehicle detected by said vehicle behavior detection means is displaced to the behavior stability side with respect to the first control ending reference set in advance as a reference on the behavior stability side with respect to the first control starting reference for the rolling behavior, the braking control for stabilizing the behavior of said vehicle, and said engine output suppressing control means ends, when the rolling behavior of said vehicle detected by said vehicle behavior detection means is displaced to the behavior stability side with respect to the second control ending reference set in advance as a reference on the behavior stability side with respect to the second control starting reference for the rolling behavior, the engine output suppressing control for stabilizing the behavior of said vehicle.

7. The behavior control apparatus for a vehicle as claimed in claim 1, further comprising accelerator operation amount detection means for detecting an accelerator operation amount of said vehicle, and wherein said acceleration intention decision means decides that the driver has an acceleration intention if the accelerator operation amount detected by said accelerator operation amount detection means becomes equal to or higher than a threshold value set in advance.

8. The behavior control apparatus for a vehicle as claimed in claim 6, further comprising accelerator operation amount detection means for detecting an accelerator operation amount of said vehicle, and wherein said acceleration intention decision means decides that the driver has an acceleration intention if the accelerator operation amount detected by said accelerator operation amount detection means becomes equal to or higher than a threshold value set in advance.

9. The behavior control apparatus for a vehicle as claimed in claim 1, further comprising accelerator operation amount increasing rate acquisition means for acquiring an increasing rate of an accelerator operation amount of said vehicle, wherein said acceleration intention decision means decides that the driver has an acceleration intention if the increasing rate of the accelerator operation amount acquired by said accelerator operation amount increasing rate acquisition means becomes equal to or higher than a threshold value set in advance.

10. The behavior control apparatus for a vehicle as claimed in claim 6, further comprising accelerator operation amount increasing rate acquisition means for acquiring an increasing rate of an accelerator operation amount of said vehicle, and wherein said acceleration intention decision means decides that the driver has an acceleration intention if the increasing rate of the accelerator operation amount acquired by said accelerator operation amount increasing rate acquisition means becomes equal to or higher than a threshold value set in advance.

11. A behavior control method for a vehicle which includes a braking mechanism for braking braking wheels of said vehicle, engine adjustment means for adjusting output power of an engine of said vehicle, and vehicle behavior detection means for detecting a behavior upon turning of said vehicle, said behavior control method being for stabilizing the behavior of said vehicle by rendering, when the behavior of said vehicle detected by said vehicle behavior detection means is displaced to the behavior instability side with respect to a first control starting reference set in advance, said braking mechanism operative to perform braking control and rendering, when the behavior of said vehicle detected by said vehicle behavior detection means is displaced to the behavior instability side with respect to a second control starting reference set in advance, said engine output adjustment means operative to perform control to suppress the engine output power, said behavior control method comprising the steps of:
inhibiting, when the driver selects that control by engine output power suppressing control means should be inhibited through control permission/inhibition selection means for artificially selecting whether engine output power suppressing control should be permitted or inhibited, the engine output power suppressing control for stabilizing the behavior of said vehicle; and
ending, when it is decided that the driver has an acceleration intention, the baking control for stabilizing the behavior of said vehicle.

12. The behavior control method for a vehicle as claimed in claim 11, wherein the behavior of said vehicle includes a behavior in a steering direction of said vehicle, and the behavior of said vehicle is stabilized by the braking control when the steering behavior of said vehicle detected by said vehicle behavior detection means is displaced to the behavior instability side with respect to the first control starting reference for the steering behavior, whereas the behavior of said vehicle is stabilized by the engine output power suppressing control when the steering behavior of said vehicle detected by said vehicle behavior detection means is displaced to the behavior instability side with respect to the second control starting reference for the steering behavior.

13. The behavior control method for a vehicle as claimed in claim 12, wherein the braking control for stabilizing the behavior of said vehicle is ended when the steering behavior of said vehicle detected by said vehicle behavior detection means is displaced to the behavior stability side with respect to a first control ending reference set in advance as a reference on the behavior stability side with respect to the first control starting reference for the steering behavior, and the engine output power suppressing control for stabilizing the behavior of said vehicle is ended when the steering behavior of said vehicle detected by said vehicle behavior detection means is displaced to the behavior stability side with respect to a second control ending reference set in advance as a reference on the behavior stability side with respect to the second control starting reference for the steering behavior.

14. The behavior control method for a vehicle as claimed in claim 11, wherein the behavior of said vehicle includes a behavior in a rolling direction of said vehicle, and the behavior of said vehicle is stabilized by the braking control when the rolling behavior of said vehicle detected by said vehicle behavior detection means is displaced to the behavior instability side with respect to the first control starting reference for the rolling behavior, whereas the behavior of said vehicle is stabilized by the engine output power suppressing control when the rolling behavior of said vehicle detected by said vehicle behavior detection means is displaced to the behavior instability side with respect to the second control starting reference for the rolling behavior.

15. The behavior control method for a vehicle as claimed in claim 14, wherein the braking control for stabilizing the behavior of said vehicle is ended when the rolling behavior of said vehicle detected by said vehicle behavior detection means is displaced to the behavior stability side with respect to a first control ending reference set in advance as a reference on the behavior stability side with respect to the first control starting reference for the rolling behavior, and the engine output power suppressing control for stabilizing the behavior of said vehicle is ended when the rolling behavior of said vehicle detected by said vehicle behavior detection means is displaced to the behavior stability side with respect to a second control ending reference set in advance as a reference on the behavior stability side with respect to the second control starting reference for the rolling behavior.

16. The behavior control method for a vehicle as claimed in claim 11, wherein it is decided that the driver has an acceleration intention if an accelerator operation amount of said vehicle becomes equal to or higher than a threshold value set in advance.

17. The behavior control method for a vehicle as claimed in claim 11, wherein it is decided that the driver has an acceleration intention if an increasing rate of an accelerator operation amount of said vehicle becomes equal to or higher than a threshold value set in advance.
